(19) United States
(12) Patent Application Publication
(10) Pub. No.: US 2026/0175868 A1
(43) Pub. Date: Jun. 25, 2026

(54) VEHICLE GUIDANCE BY A MULTIMODAL LARGE LANGUAGE MODEL

(71) Applicant: Zoox, Inc., Foster City, CA (US)

(72) Inventors: Till Sebastian Hartmann, Brookline, MA (US); James Philip Robinson-Bohnslav, East Walpole, MA (US); Vishaal Samir Saraiya, Foster City, CA (US); Oytun Ulutan, Buena Park, CA (US)

(21) Appl. No.: 18/991,070

(22) Filed: Dec. 20, 2024

(51) Int. Cl. B60W 60/00; G01C 21/36

(52) U.S. Cl. CPC B60W 60/001; G01C 21/3602; B60W 2420/403; B60W 2556/45; B60W 2756/10

(57) ABSTRACT

Techniques for determining text for a vehicle to navigate in an environment are described herein. For example, the techniques may include a vehicle computing device of an autonomous vehicle transmitting data to a remote computing device that implements a multimodal large language model to determine text data that enables the vehicle to navigate in problematic situations. The multimodal large language model can receive image data, map, data, sensor data, and/or other data from the vehicle (or database associated with therewith) and output text describing a solution for navigating relative to an event. The text output by the multimodal large language model can be transmitted to the vehicle computing device for predicting a vehicle trajectory (or another action) for the autonomous vehicle to follow at a future time.

### BACKGROUND

Machine learned models can be employed to predict an action for a variety of robotic devices. For instance, planning systems in autonomous and semi-autonomous vehicles determine actions for a vehicle to take in an operating environment. Actions for a vehicle may be determined based in part on avoiding objects present in the environment. For example, an action may be generated to yield to a pedestrian, to change a lane to avoid another vehicle in the road, or the like. However, in certain situations, the vehicle may be unable to navigate past a portion of the environment that impedes progress of the vehicle. Further, computational resources coupled to the vehicle for determining the actions may limit an amount of time and/or the types of actions that the vehicle can determine in certain scenarios.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a pictorial flow diagram of an example process for implementing vehicle guidance techniques described herein.

FIG. 2 illustrates an example block diagram of an example computing device for implementing techniques to determine guidance for an autonomous vehicle, as described herein.

FIG. 3 illustrates an example block diagram of an example computing architecture for implementing techniques to determine guidance for an autonomous vehicle, as described herein.

FIG. 4 is a block diagram of an example system for implementing the techniques described herein.

FIG. 5 is a flowchart depicting an example process for determining text for guiding an autonomous vehicle relative to an event using an example multimodal large language model.

### DETAILED DESCRIPTION

A vehicle may request assistance from a remote entity to navigate in some scenarios in an environment. Delays by the remote entity to provide the vehicle assistance may cause the vehicle to remain in place until the assistance is provided, which may delay progress of the vehicle, detract from an experience of a passenger of the vehicle, and may potentially impact the safety of the passenger.

This application describes techniques for determining actions for a vehicle to navigate in an environment. For example, the techniques may include a vehicle computing device of the vehicle (e.g., an autonomous vehicle) transmitting data to a remote computing device that implements a multimodal large language model to determine text data that enables the vehicle to navigate in problematic situations and/or to provide additional guidance to remote operators. The multimodal large language model can receive image data, map, data, sensor data, and/or other data from the vehicle (or database associated therewith) and output text describing a solution (e.g., a position, change lane, yield, do not yield, follow instructions from human, etc.) for navigating relative to an event. In various examples, the model may additionally or alternatively receive a prompt (e.g., in text or other modality specifying “how should the vehicle respond in this situation”). The text output by the multimodal large language model can be transmitted to the vehicle computing device for predicting a vehicle trajectory for the vehicle to follow at a future time. In some examples, such text may be presented to a remote operator to aid the remote operator in rendering guidance to the vehicle. In some examples, the text may be considered during vehicle planning thereby improving vehicle safety as the vehicle navigates in the environment by providing solutions to events that the vehicle computing device may otherwise be delayed in determining due to the limited available computation resources.

The guidance techniques can be used to generate text that describes a problem and a solution for an autonomous vehicle to navigate in an environment. As mentioned, the text can be transmitted directly to a computing device of the autonomous vehicle for consideration during planning operations. Additionally, or alternatively, the guidance techniques can include the multimodal large language model outputting text data to a remote operator such as sending a problem the autonomous vehicle encountered in an environment and a potential solution to the problem for the remote operator to validate or modify. The guidance techniques discussed here can enable the autonomous vehicle to receive data that cause fewer instances to require input from a remote operator (e.g., a human trained to navigate the vehicle remotely or provide instructions for the vehicle to consider for navigation). In examples that include the remote operator validating the text output by the multimodal large language model, increased efficiency can be gained by presenting the remote operator with text (which may be a question) that enables the remote operator to validate or otherwise determine a solution for the autonomous vehicle in less time. For example, the multimodal large language model can interpret image data, map data, log data, etc. in the environment to perform some or all of the functionality that the remote operator would otherwise be required to perform.

The techniques described herein can include a robotic device such as (e.g., an autonomous vehicle) transmitting data to a remote computing device that may have greater computational resources available for determining how to navigate difficult events in an environment relative to the computational resources coupled to the robotic device. For example, processor, memory, and/or power available to a computing device coupled to the robotic device may cause the robotic device to take more time to determine how to navigate an event in the environment relative to other processor, memory, and/or power resources available to a remote computing device. The remote computing device can implement a model or component that outputs text representing a description of the event and a solution that enables the robotic device to navigate relative to the event safely and efficiently. For example, the robotic device can send a request for assistance to a large language model that determines text describing the event and a trajectory, position, or other action that the robotic device can use to safely navigate relative to the event in the future.

By way of example and not limitation, an autonomous vehicle can encounter an event such as a person directing traffic, an object (e.g., another vehicle a pedestrian, etc.) behaving unexpectedly, a construction zone, among others, and the receive text data from a remote computing device that enables the autonomous vehicle to navigate relative to the event. The remote computing device can implement a model (e.g., a multimodal large language model) that is different from another model of a vehicle computing device coupled to the autonomous vehicle. The model implemented by the remote computing device can provide more insightful, detailed, or human-like analysis than the model of the vehicle computing device due to having more computational resources available than those available to the vehicle computing device. For instance, the event can include a human authorized to direct traffic (e.g., a flagger, a hotel employee, etc.) communicating with the autonomous vehicle, and the remote computing device can determine instructions for the autonomous vehicle that prevents the autonomous vehicle from remaining stationary or otherwise delaying a response for an extended period of time. The techniques can include the autonomous vehicle receiving waypoints, a trajectory, or other data as text that the vehicle computing device processes to generate an action that successfully navigates the autonomous vehicle in the event.

The autonomous vehicle can send a request for assistance to a remote computing device having more available computational resources than those available locally on the autonomous vehicle. In various examples, the remote computing device can receive data associated with the autonomous vehicle including one or more of: sensor data associated with a sensor(s), image data, state data, planner data, prediction data, map data, etc. For instance, the autonomous vehicle can transmit data representing map data, image data, raw sensor data, processed sensor data, or the like, to the remote computing device at pre-determined intervals (e.g., send map data for storage in a database) and/or in a request for assistance. The remote computing device can input the data into a machine learned model (e.g., a multimodal large language model) that generates text for an event proximate the autonomous vehicle. For example, the remote computing device can input the data into an encoder, a tokenizer, or other model that pre-processes multiple types of input data into a common encoding format for processing by the machine learned model. Using the guidance techniques described herein can improve how the autonomous vehicle reacts to another object(s) or event to reduce instances in which the autonomous vehicle might otherwise take more time to determine a solution using localized computational resources.

In some examples, the techniques described herein can enable a vehicle computing device coupled to an autonomous vehicle to consider potentially adverse behavior by the object thereby improving safety (and passenger comfort) as the vehicle navigates in the environment. In various examples, adverse behavior by the object can represent a behavior by the object that affects or has the potential to affect operation of the vehicle such as requiring the vehicle to move or change speed to avoid a collision or near miss (e.g., moves towards the autonomous vehicle, performs a sudden or erratic action, fails to yield right-of-way, ignores a traffic sign or light, etc.).

Data output by a machine learned model of a remote computing device can, in various examples, be transmitted to and used by the vehicle computing device to perform a simulation, control a vehicle, and/or validate performance of the vehicle or component thereof. For example, text data determined by the machine learned model can represent waypoints, a position, a trajectory, or the like usable as a cost and/or in a tree structure to control the vehicle. Additionally, or alternatively, an output by the machine learned model can represent a discrete action, a waypoint, etc. that is in a data format other than text (e.g., an instruction to pull over, continue, stop and hold, a trajectory, etc.). By generating the text data as described herein, the machine learned model can improve operation of the vehicle by enabling more realistic reference actions in a tree structure (e.g., to plan for a greater variance of potential object positions or actions).

As mentioned, the machine learned model may be configured to determine text data based on sensor data from one or more sensors associated with an autonomous vehicle. The text data predicted by the machine learned model described herein may be based on passive prediction (e.g., independent of an action the autonomous vehicle and/or another object takes in the environment, substantially no reaction to the action of the autonomous vehicle and/or other objects, etc.), active prediction (e.g., based on a reaction to an action of the autonomous vehicle and/or another object in the environment), or a combination thereof.

In various examples, aspects of the processing operations may be parallelized and input to a parallel processor unit such as in parallel by a parallel processing unit, a GPU and/or in parallel by multiple GPUs for efficient processing. Accordingly, implementing the techniques described herein can efficiently make use of available computational resources (e.g., memory and/or processor allocation or usage) while also improving accuracy of predictions.

In some examples, a model or component may define processing resources (e.g., processor amount, processor cycles, processor cores, processor location, processor type, and the like) to use to predict text for a vehicle to use at a future time. For example, a computing device (e.g., a remote computing device and/or vehicle computing device) can implement various models that may have access to different processors (e.g., a parallel processing unit, Central Processing Units (CPUs), Graphics Processing Units (GPUs), Tensor Processing Units (TPUs), multi-core processor, and the like). Models may define processing resources to utilize a processor that most efficiently (e.g., uses the least amount of computational time) outputs a prediction. In some examples, a model may generate text by processing data associated with the object and/or the vehicle using a CPU, GPU, TPU, or a combination thereof. In this way, the model may be defined to utilize the processing resources that enable the model to perform predictions in the least amount of time (e.g., to use the corrected pose data in planning considerations of the vehicle). Accordingly, a model may make the best use of available processing resources and enable more predictions that may improve how a vehicle navigates in relation to the objects.

As described herein, models may be representative of machine learned models, statistical models, heuristic models, or a combination thereof. That is, a model may refer to a machine learning model that learns from a training dataset to improve accuracy of an output (e.g., a prediction). Additionally or alternatively, a model may refer to a statistical model that is representative of logic and/or mathematical functions that generate approximations which are usable to make predictions.

The techniques discussed herein may improve a functioning of a vehicle computing system in a number of ways. The vehicle computing system may determine an action for the autonomous vehicle to take based on guidance data from a remote machine learned model (e.g., text from a multimodal large language model). In some examples, using the guidance techniques described herein can enable a vehicle to consider instructions from a human proximate ethe vehicle, adverse object behavior, etc. to improve safe operation of the vehicle by accurately characterizing the instructions from the human and/or future actions of the object with greater detail as compared to previous models.

The techniques discussed herein can also improve a functioning of a computing device in a number of additional ways. In some examples, evaluating or processing an output by a model(s) may allow an autonomous vehicle to generate more accurate and/or safer trajectories for an autonomous vehicle to traverse an environment using fewer computational resources. In at least some examples described herein, text data from a large language model may account for object to autonomous vehicle dependencies and/or relatively rare actions by the object, causing safer decision-making by the computing device.

The techniques can include the model optimizing available computational resources by performing operations that limit an impact on the available resources (as compared to not implementing the component). Utilizing output data (e.g., text data) from a remote model by a vehicle computing device, for instance, can improve the accuracy and/or reduce a latency for the vehicle to respond to a potential collision or unusual events in the environment. For example, implementing the model can improve safety of a vehicle by efficiently outputting text data over time that is usable to determine an optimal planned trajectory for consideration during planning operations.

In some examples, the techniques can be used in a self-test operation associated with a system to evaluate a performance of the system which provides for greatly improved overall reliability and safety outcomes. Further, the techniques discussed herein may be incorporated into a system that can be validated for safety. These and other improvements to the functioning of the computing device are discussed herein.

The methods, apparatuses, and systems described herein can be implemented in a number of ways. Example implementations are provided below with reference to the following figures. Although discussed in the context of an autonomous vehicle in some examples below, the methods, apparatuses, and systems described herein can be applied to a variety of systems. In one example, machine learned models may be utilized in driver-controlled vehicles in which such a system may provide an indication of whether it is safe to perform various maneuvers. In another example, the methods, apparatuses, and systems can be utilized by a robotic device in an aviation or nautical context, or other context. Additionally, or alternatively, the techniques described herein can be used with real data (e.g., captured using sensor(s)), simulated data (e.g., generated by a simulator), or any combination thereof.

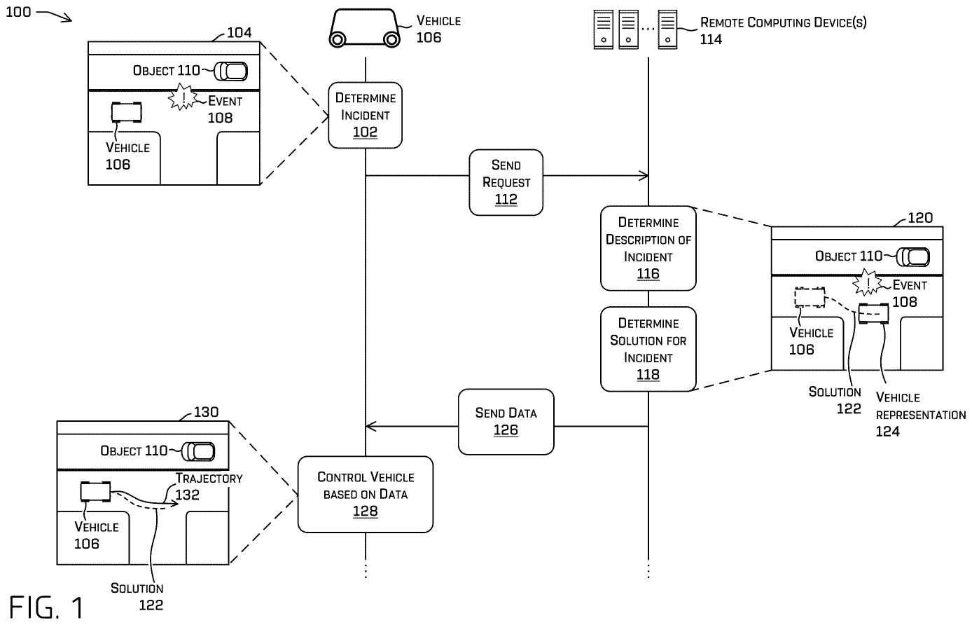

FIG. 1 is a pictorial flow diagram of an example process 100 for implementing vehicle guidance techniques described herein. For example, the example process 100 can include receiving a request for assistance from a vehicle, determining a solution for the vehicle, sending the solution to the vehicle, and causing a computing device of the vehicle to control the vehicle based on the solution.

At operation 102, the process can include determining an event that impacts operation of the vehicle. An example 104 illustrates a vehicle 106, an event 108, and an object 110 (e.g., another vehicle) in the environment. In various examples, a vehicle computing device of the vehicle 106 may detect the event 108 (e.g., a potential collision, an obstacle, blocked region, a road closure, a construction zone, signals from a traffic signal or human traffic coordinator, etc.) by capturing sensor data of an environment. In some examples, the sensor data can be captured by one or more sensors on the vehicle 106. For example, the sensor data can include data captured by a lidar sensor, an image sensor, a radar sensor, a time of flight sensor, a sonar sensor, and the like. The event 108 may also be determined based on map data, or other data as describe herein.

In some examples, the operation 102 can include determining a classification of an object (e.g., to determine that an object is a pedestrian in an environment). The operation 102 can include determining attributes of the object 110 to determine a location, velocity, heading, etc. of the object 110.

In some examples, the guidance techniques described herein may be implemented at least partially by or in association with a vehicle computing device (e.g., vehicle computing device(s) 404) and/or a remote computing device (e.g., the computing device(s) 434). The example 104 may, for example, be associated with a real-world environment or simulated environment, depending on examples.

In some instances, the vehicle 106 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the vehicle 106 may be a fully or partially autonomous vehicle having any other level or classification.

At operation 112, the process can include sending a request for assistance to a remote computing device(s) 114. For instance, the vehicle 106 may send a request for assistance to navigate past or relative to the event 108 to the remote computing device(s) 114. The remote computing device(s) 114 may be located remote from the vehicle 106, such as at a teleoperations center that supports a fleet of autonomous vehicles. However, in some examples, the vehicle 106 can perform the operations discussed in the process 100. In some examples, the vehicle 106 may determine to send a request for assistance based on detecting the event 108 and/or based on an object classification (e.g., to verify a classification). Additional details of sending requests for assistance to a remote operator is described in U.S. patent application Ser. No. 15/644,349, filed on Jul. 7, 2017, entitled “Predictive Remote operator Situational Awareness,” and in U.S. patent application Ser. No. 16/852,116, filed on Apr. 17, 2020, entitled “Teleoperations for Collaborative Vehicle Guidance,” which are incorporated herein by reference in their entirety and for all purposes.

At operation 116, the process can include determining a description of the event 108 to follow at a future time. For example, the remote computing device(s) 114 can implement a multimodal large language model to determine text describing the event 108. The multimodal large model can receive a variety of data including for example sensor data from the vehicle 106, image data, and/or map data describing a vicinity of the vehicle 106, just to name a few. In some examples, the map data can be sent by the vehicle 106 independent of the request at predetermined intervals and store the database (not shown) for access at a later time. By way of example and not limitation, the description for the event 108 can include text indicating the vehicle 106 received instructions from a human traffic coordinator (e.g., to pick up a passenger at a hotel, navigate in a parking lot or roadway, etc.).

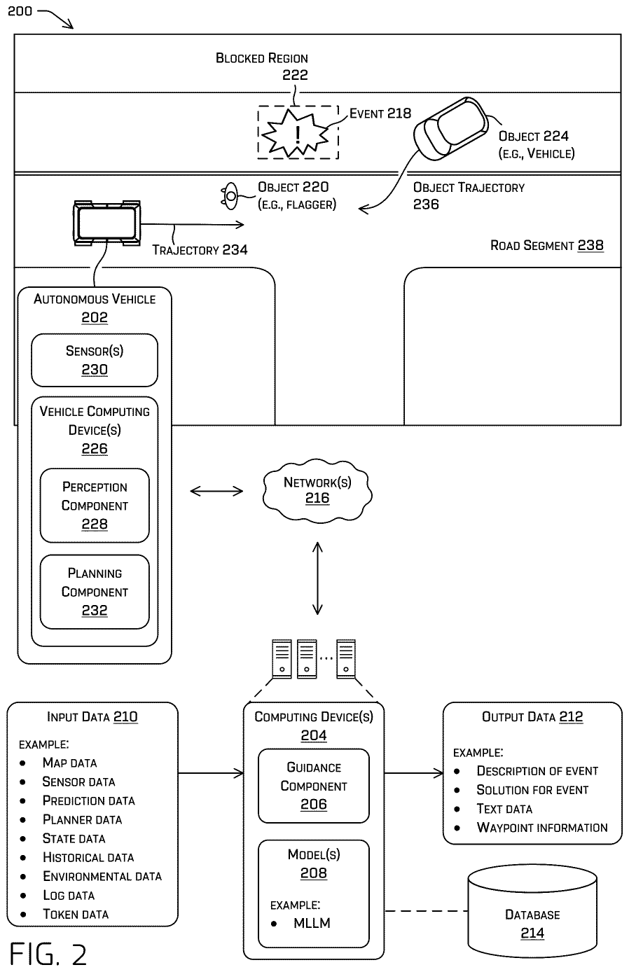

At operation 118, the process can include determining a solution for the event 108 to follow at a future time. For example, the remote computing device(s) 114 can implement the multimodal large language model to determine text describing the event 108. As illustrated in example 120, the solution 122 may be representative of text describing a position, waypoints, a lane, a discrete action, or other instruction for navigating relative to the event 108. Additional details of determining guidance are discussed in connection with FIGS. 2-5, as well as throughout this disclosure. In some examples, solution 122 can include text describing a position for a vehicle representation 124 at a future time.

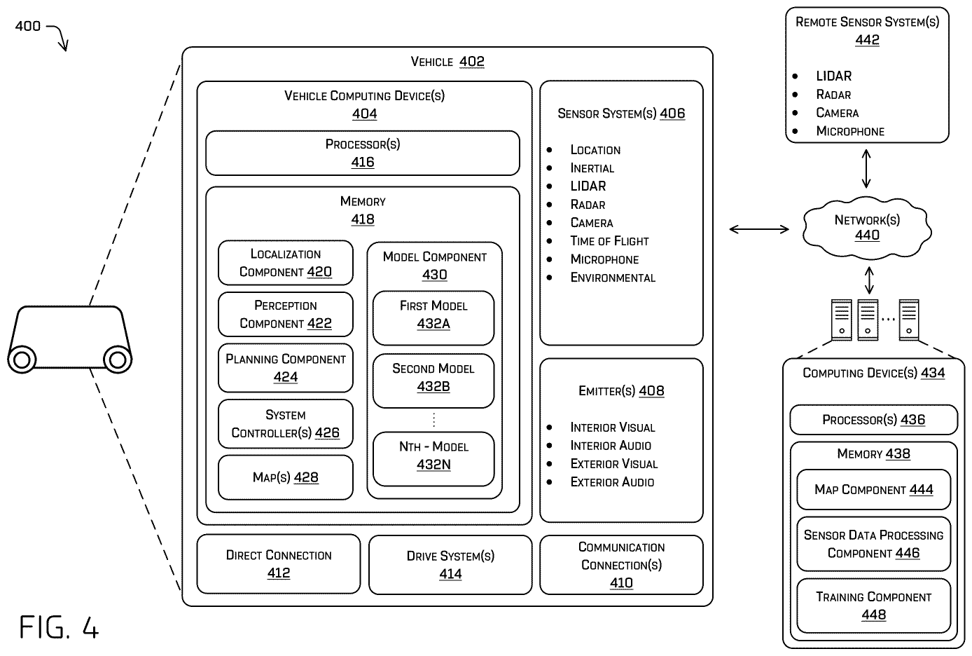

At operation 126, the process can include the remote computing device(s) 114 sending data indicative of the solution(s) to the vehicle 106. The solution 122 may comprise text representing at least one of: acceleration data, velocity data, position data, and so on. Additional details of sending communications via a network are discussed in connection with FIG. 4, as well as throughout this disclosure.

At operation 128, the process can include controlling a vehicle based at least in part on the data. As illustrated in example 130, the operation 128 can include generating a trajectory 132 for the vehicle 106 to follow (e.g., to avoid the event 108 and/or the object 110). In various examples, controlling the autonomous vehicle may comprise stopping the vehicle and/or controlling at least one of: a braking system, an acceleration system, or a drive system of the vehicle. Additionally, or alternatively, controlling the vehicle may comprise adjusting a setting or parameter associated with a component or model of a vehicle computing device. Additional details of controlling steering, acceleration, braking, and other systems of the vehicle is described in U.S. patent application Ser. No. 16/251,788, filed on Jan. 18, 2019, entitled “Vehicle Control,” which is incorporated herein by reference in its entirety.

FIG. 2 illustrates an example block diagram 200 of an example computing device for implementing techniques to determine guidance for an autonomous vehicle (autonomous vehicle 202), as described herein.

As depicted in FIG. 2, one or more computing devices 204 (also referred to herein as the computing device(s) 204) comprises a guidance component 206 and one or more models 208 (also referred to herein as the model(s) 208). As shown in the example of FIG. 2, the guidance component 206 and/or the model(s) 208 can receive input data 210 for processing to generate output data 212 representing text describing an event and/or a solution to the event. The input data may be received from the autonomous vehicle 202 and/or from a database such as database 214 associated with the computing device(s) 204.

In some examples, the autonomous vehicle 202 may send a request for assistance to the computing device 204 via a network(s) 216, and the guidance component 206 can implement at least one of the model(s) 208 (e.g., a multimodal large language model) describing an event 218 in an environment (e.g., a real-world environment). The computing device(s) 204 can implement a large language model to provide a general understanding of the environment (or scenes therein) based on map data, image data, etc. for handling edge cases, long tails, etc. that another model (e.g., coupled to the vehicle) may be less likely to understand. For instance, the large language model can be trained to provide “reasoning” that enables descriptions and/or solutions of various types of events that may occur in the environment. The event 218 may be associated with an object 220 representing a human controlling traffic (e.g., a flagger, parking lot attendant, police officer, hotel representative, etc.), a blocked region 222, or otherwise. The blocked region 222 may impact operation of the autonomous vehicle 202 and/or one or more other objects such as object 224 (e.g., another vehicle, also referred to herein as the vehicle 224).

The computing device(s) 204 can represent a server which may be associated with a teleoperations center that may provide remote assistance to one or more autonomous vehicles in a fleet. The computing device(s) 204 may also or instead include a user interface for a human operator to assist in providing guidance to the autonomous vehicle 202. In some examples, the teleoperations center may provide guidance (e.g., a new instruction, a modified instruction output by the machine learned model, a modified instruction from the autonomous vehicle, a suggested command, or the like) to the vehicle in response to a request for assistance from the vehicle. Additional details of determining when to contact a remote operator as well as techniques for navigating the autonomous vehicle using instructions that are received from the remote operator are described in U.S. patent application Ser. No. 16/457,289, filed Jun. 28, 2019, entitled “Techniques for Contacting a Remote operator,” which is incorporated herein by reference in its entirety and for all purposes. Additional details of navigating the autonomous vehicle using instructions that are received from the remote operator are further described in U.S. patent application Ser. No. 16/457,341, filed Jun. 28, 2019, entitled “Techniques for Navigating Vehicles using Teleoperations Instructions,” which is incorporated herein by reference in its entirety and for all purposes.

In various examples, the guidance component 206 may receive the input data 210 representing one or more of: map data (e.g., from the database 214), sensor data, prediction data (e.g., from a prediction component), planner data (e.g., from a planner component), state data associated with the vehicle and/or an object in the environment (e.g., object 224) in the environment. In some examples, the input data 210 can be received from the autonomous vehicle 202, the database 214, and/or another vehicle in a fleet associated with the autonomous vehicle 202, to name a few. The guidance component 206 may be configured to determine text representing a solution to navigate relative to the event 218. In some examples, the output data 212 can represent an instruction (e.g., a reference trajectory, an acceleration range, a velocity range, a position range, an object intent, and so on) for the autonomous vehicle 202 to follow at a future time. In some examples, the output data 212 can represent an instruction to cause the event 218 to be displayed on a display device of the autonomous vehicle 202 to inform an occupant(s) of the event 218.

In some examples, the input data 210 can include state data representing one or more of position data, orientation data, heading data, velocity data, speed data, acceleration data, yaw rate data, or turning rate data associated with the object and/or the vehicle. The input data may also or instead include historical data representing one or more of: previous actions, positions, actions, etc. and the map data can describe traffic rules, a junction type, junction geometry, static objects, etc. The input data 210 can also or instead represent data associated with a sensor (e.g., coupled to the vehicle, coupled to another vehicle, or in the environment). In some examples, the input data 210 can include environment data can representing weather data, data describing a time of day, time of year, etc. and/or log data associated with an object, the vehicle, and/or another vehicle in a fleet of vehicles associated with the autonomous vehicle 202.

In various examples, one or more vehicle computing device 226 may be configured to detect one or more objects (e.g., the object 220, the object 224) and/or the event 218 in the environment, such as via a perception component 228. In some examples, the vehicle computing device(s) 226 may detect the one or more objects, based on sensor data received from one or more sensors 230. In some examples, the sensor(s) 230 may include sensors mounted on the autonomous vehicle 202, and include, without limitation, ultrasonic sensors, radar sensors, light detection and ranging (lidar) sensors, cameras, microphones, inertial sensors (e.g., inertial measurement units, accelerometers, gyros, etc.), global positioning satellite (GPS) sensors, and the like. In some examples, the sensor(s) 230 may include one or more remote sensors, such as, for example sensors mounted on another autonomous vehicle, and/or sensors mounted in the environment.

In various examples, the autonomous vehicle 202 may be configured to transmit and/or receive data from other autonomous vehicles and/or the sensor(s) 230. The data may include historical data, log data, and/or sensor data associated with the objects, the event, regions, or the like detected in the environment. The data may include sensor data, such as data regarding the object 220, the object 224, and/or the event 218 detected in the environment. In various examples, the environment may include the sensor(s) 230 for traffic monitoring, collision avoidance, or the like. In some examples, the sensor(s) 230 may be mounted in the environment to provide additional visibility in an area of reduced visibility, such as, for example, in a blind or semi-blind intersection.

In various examples, the vehicle computing device(s) 226 may receive the sensor data and may determine a type of an object (e.g., classify the type of object), such as, for example, whether the object is a vehicle, such as the object 224, a vehicle, a truck, a motorcycle, a moped, a pedestrian or human, such as object 220, or the like. The objects may include static objects (e.g., buildings, bridges, signs, etc.) and dynamic objects such as other vehicles, pedestrians, bicyclists, or the like. In some examples, a classification may include another vehicle (e.g., a car, a pick-up truck, a semi-trailer truck, a tractor, a bus, a train, etc.), a pedestrian, a child, a bicyclist, a skateboarder, an equestrian, an animal, or the like. In various examples, the classification of the object may be used by a model or component to determine object characteristics (e.g., maximum speed, acceleration, maneuverability, candidate positions, etc.). In some examples, potential states, positions, and/or trajectories (also referred to as a candidate trajectory or predicted trajectory herein) by an object may be considered based on characteristics of the object (e.g., how the object may potentially move or operate in the environment).

The input data 210 can include, for example, historical data representing object positions, trajectories, actions, etc. for one or more objects proximate the autonomous vehicle 202 at a previous time. The historical object data may be conditioned on a type of action by the object (e.g., a stop action, a left-turn action, an acceleration action, a braking action, etc.). In some examples, state data associated with an object (e.g., position, orientation, velocity, acceleration, etc.) can be used by the guidance component 206 to determine text describing the event 218, the blocked region 222, etc. In some examples, the output data 212 can be based on an object type, capabilities of the object type (e.g., a maximum deceleration, a maximum acceleration, etc.), detection of a construction zone, a type of event, or the like. In some examples, the output data 212 can indicate (e.g., with text data or non-text data) an intent of an object (e.g., a group of pedestrians is likely to not enter the roadway, etc.).

In some examples, the computing device(s) 204 can generate the output data 212 for different times in the future. For instance, at a given time, the guidance component 206 and/or the model(s) 208 can generate the output data 212 for different times in the future (e.g., every 0.1 second for four second, or some other time period or frequency). In various examples, the guidance component 206 and/or the model(s) 208 can iteratively determine the output data 212 for each future time based at least in part on the output data 212 associated with a previous time.

In various examples, the vehicle computing device(s) 226 may include a planning component 232. In general, the planning component 232 may determine a trajectory 234 for the autonomous vehicle 202 to follow to traverse through the environment. For example, the planning component 232 may determine various routes and trajectories and various levels of detail based on the output data 212 received from the computing device(s) 204. In some examples, the planning component 232 may determine a route to travel from a first location (e.g., a current location) to a second location (e.g., a target location) based on the output data 212 received from the computing device(s) 204. For example, the output data 212 can represent an instruction (e.g., a trajectory, a waypoint, a pull over instruction, a lane change instruction, a continue operation, an object intent, etc.). The planning component 232 may determine (via a machined-learned model, for example) an object trajectory 236 for the object 224 that is the most likely trajectory that the object 224 may take in the future. Though not shown in FIG. 2, the planning component 232 may also determine one or more trajectories for the object 220.

FIG. 2 also depicts the vehicle 224 associated with the blocked region 222. The blocked region 222 may represent a blocked lane or other region impassible to the autonomous vehicle 202 and/or the vehicle 224 in the environment. In the illustrated example of FIG. 2, the vehicle 224 is associated with a trajectory 234 to go around the blocked region 222 caused by the event 218 by entering a road segment 238 occupied by the autonomous vehicle 202. The autonomous vehicle 202 can send a request for assistance to the computing device(s) 204 via the network(s) 216 based at least in part on detecting the event 218, a potential collision with vehicle 224 entering the road segment 238, the object 220 directing traffic, among others.

In some examples, the request for assistance may comprise sensor data and/or vehicle state data describing a position, a velocity, an acceleration, and other aspects of the autonomous vehicle relative to the surrounding environment. For example, vehicle state data of the autonomous vehicle 202 may indicate a current trajectory (e.g., trajectory 234), a rate or range of acceleration, velocity, and/or braking capabilities. In some examples, the computing device(s) 204 receives the request for assistance and generates guidance (e.g., a text description, a text solution, and/or an instruction for the autonomous vehicle 202) using the guidance component 206 and/or the model(s) 208.

The vehicle computing device(s) 226 can use or otherwise process the output data 212 in a variety of ways. For example, the output data 212 represent a waypoint, text describing the event 218, text describing a way to avoid the event 218 at a future time. The output data 212 can, for example, control the autonomous vehicle 202 (e.g., determine a trajectory, used as a cost by an algorithm, used as a node in a tree structure, etc.). For example, vehicle computing device(s) 226 can include a component or model to process language such as text data and/or to receive non-text data representing the output data 212 for use by the planning component 232 that is configured to determine planner data (e.g., a vehicle trajectory, an object trajectory, an output by a tree structure, etc.). The planner data can include one or more vehicle trajectories (candidate trajectories to avoid objects) and/or one or more object trajectories, just to name a few. The planner data can also or instead represent determinations made by a tree structure that is configured with reference actions corresponding to different textual descriptions and/or solutions and associated object positions output from the perception component 228.

In examples that include a vehicle trajectory (e.g., the trajectory 234) as input data, the planning component 232 can modify, based on the output data 212, the trajectory as a modified trajectory to account for the text data. That is, the trajectory received as input can be altered to nudge or otherwise move the trajectory a threshold distance to enable a path around the event 218.

In some examples, the vehicle computing device(s) 226 can use the output data 212 to perform a simulation, control a vehicle (e.g., determine a candidate vehicle trajectory and/or control a propulsion system, a braking system, or a steering system), validate or test performance of a vehicle or component thereof, to name a few. The planning component 232 (or other component) can, for example, determine one or more object positions for use in a tree structure to control the autonomous vehicle 202 (e.g., a reference action associated with an object probability can be included in a tree structure). The object positions output by the guidance component 206 can improve vehicle planning operations by enabling more realistic reference actions in a tree structure (e.g., to plan for a greater variance of potential object positions).

In some examples, the guidance component 206 can employ a user interface to present the output data 212 describing the event to a remote operator for validation. For example, the guidance component 206 can determine a confidence level in the output data 212 (e.g., in the text describing and/or solving the cause of the event) and send the output data 212 to the remote operator in examples when the confidence level meets or exceeds a confidence threshold. The guidance component 206 may, for example, receive an instruction from the remote operator via a user interface output on a display device of the computing device(s) 204 (e.g., to control the autonomous vehicle 202 or a representation thereof). The user interface may, in some examples, be configured to receive an input from the controls (e.g., of the vehicle representation). In some various examples, one or more of the controls (e.g., a steering control, a braking control, and/or acceleration control) may be associated with steering, braking, and/or acceleration capabilities of the vehicle in the environment based at least in part on the vehicle state data (or other data) received from the autonomous vehicle 202.

In some examples, the road segment 238 may be associated with map feature data describing attributes of the road segment (e.g., a start point, an endpoint, road condition(s), a road segment identification, a lane number, and so on). Some or all of the attributes of the road segment 238 may be transmitted to the autonomous vehicle 202 as part of the text data sent to the autonomous vehicle 202 from the computing device(s) 204.

In some examples, the guidance component 206 may be configured to receive and/or determine vector representations of one or more of: environment data (e.g., top-down view data), object state(s), and vehicle state(s). For example, the guidance component 206 can receive data from a machine learned model (e.g., a Graph Neural Network (GNN)) representing one or more vectors of features in the environment (e.g., a roadway, a crosswalk, a building, etc.), a current state of an object (e.g., the object 220 and/or the object 224), and/or a current state of the autonomous vehicle 202. In other examples, the feature vector(s) can represent a rasterized image based on top-down view data. Additional details about inputs to the guidance component 206 are provided throughout this disclosure. Additional details of predicting object locations using a GNN are described in U.S. patent application Ser. No. 17/535,357, filed on Nov. 24, 2021, entitled “Encoding Relative Object Information Into Node Edge Features,” which is incorporated herein by reference in its entirety and for all purposes.

In some examples, the input data 210 for the guidance component 206 (or other models discussed herein) can include a top-down representation (e.g., such that multiple layers or channels of an “image” represent data of the environment from a perspective of looking down at a driving surface) and/or a feature vector of the environment (e.g., some embedding or encoding representative of the environment), the object, and/or the autonomous vehicle. In some examples, a computing device can receive sensor data, log data, map data, and so on, as input and determine top-down representations and/or feature vectors representing an object, a vehicle, and/or an environment. For example, a machine learned model (e.g., a graph neural network) can determine the feature vectors based at least in part on input data representing an object position, an object trajectory, an object state, vehicle information, a simulated scene, a real-world scene, etc. The computing device can receive the feature vectors from the machine learned model as part of the input data 210. In various examples, the feature vectors may be generated to represent a current state of the object (e.g., a heading, a speed, etc.) and/or a behavior of the object over time (e.g., a change in yaw, speed, or acceleration of the object). In some examples, the machine learned model can determine additional feature vectors to represent other objects and/or features of the environment.

In some examples, a machine learned model may receive a vector representation of data compiled into an image format representing a top-down view of an environment. The top-down view may be determined based at least in part on map data and/or sensor data captured from or associated with a sensor of an autonomous vehicle in the environment. The vector representation of the top-down view can represent one or more of: an attribute (e.g., position, class, velocity, acceleration, yaw, turn signal status, etc.) of an object, history of the object (e.g., location history, velocity history, etc.), an attribute of the vehicle (e.g., velocity, position, etc.), crosswalk permission, traffic light permission, right-of-way information, etc. The data can be represented in a top-down view of the environment to capture context of the autonomous vehicle (e.g., identify actions of other vehicles and pedestrians relative to the vehicle).

In some examples, the guidance component 206 (or other models discussed herein) may receive, as input data, vector representation(s) of data associated with one or more objects in the environment. For instance, the guidance component 206 can receive (or in some examples determine) one or more vectors representing one or more of: position data, orientation data, heading data, velocity data, speed data, acceleration data, yaw rate data, or turning rate data associated with the object.

In various examples, the vehicle computing device 226 may be configured to determine actions for a vehicle to take while operating (e.g., trajectories to use to control the vehicle) based on the output data 212 determined by the guidance component 206. The actions may include a reference action (e.g., one of a group of maneuvers the vehicle is configured to perform in reaction to a dynamic operating environment) such as a right lane change, a left lane change, staying in a lane, going around an obstacle (e.g., double-parked vehicle, a group of pedestrians, etc.), or the like. The actions may additionally include sub-actions, such as speed variations (e.g., maintain velocity, accelerate, decelerate, etc.), positional variations (e.g., changing a position in a lane), or the like. For example, an action may include staying in a lane (action) and adjusting a position of the vehicle in the lane from a centered position to operating on a left side of the lane (sub-action).

For each applicable action and sub-action, the vehicle computing system may implement different model(s) and/or component(s) to simulate future states (e.g., estimated states) by projecting an autonomous vehicle and relevant object(s) forward in the environment for the period of time (e.g., 5 seconds, 8 seconds, 12 seconds, etc.). The model(s) may project the object(s) (e.g., estimate future positions of the object(s)) forward based on a predicted trajectory associated therewith. For instance, the model(s) may predict a trajectory of a vehicle and predict attributes about the vehicle including whether the trajectory will be used by the vehicle to arrive at a predicted location in the future. The vehicle computing device may project the vehicle forward (e.g., estimate future positions of the vehicle) based on the vehicle trajectories output by the model. The estimated state(s) may represent an estimated position (e.g., estimated location) of the autonomous vehicle and an estimated position of the relevant object(s) at a time in the future. In some examples, the vehicle computing device may determine relative data between the autonomous vehicle and the object(s) in the estimated state(s). In such examples, the relative data may include distances, locations, speeds, directions of travel, and/or other factors between the autonomous vehicle and the object. In various examples, the vehicle computing device may determine estimated states at a pre-determined rate (e.g., 10 Hertz, 20 Hertz, 50 Hertz, etc.). In some examples, the rate at which the estimated states are determined may vary over time and/or based on one or more conditions (e.g., speed of the vehicle, speed of objects in the environment, number of objects in the environment, type of operational drive domain (e.g., residential street vs. highway), whether the vehicle is occupied, etc. In at least one example, the estimated states may be performed at a rate of 10 Hertz (e.g., 80 estimated intents over an 8 second period of time).

In various examples, the vehicle computing system may store sensor data associated with an actual location of an object at the end of the set of estimated states (e.g., end of the period of time) and use this data as training data to train one or more models. For example, stored sensor data (or perception data derived therefrom), token data, text data, log data, etc. may be retrieved by a model and be used as input data to identify cues of an object, an event, etc. (e.g., identify a position, a feature, an attribute, or a pose of the object). Such training data may be determined based on manual annotation and/or by determining a change associated semantic information of the position and/or orientation of the object between times in the stored data. Further, detected positions over such a period of time associated with the object may be used to determine a ground truth position to associate with the object.

In some examples, the vehicle computing device may provide data such as token data, log data, sensor data, training data, etc. to a remote computing device (i.e., computing device separate from vehicle computing device) for data analysis. In such examples, the remote computing device may analyze the data to determine one or more labels for images, an actual location, yaw, speed, acceleration, direction of travel, or the like of the object at the end of the set of estimated states. In some such examples, ground truth data may be associated with one or more of: positions, trajectories, accelerations, and/or directions of objects represented in the stored data. The ground truth data may be determined (either hand labelled or determined by another machine learned model) and such ground truth data may be used to determine a position of an object. In some examples, corresponding data may be input into the model to determine an output and a difference between the determined output, and the actual action by the object (or actual position data) may be used to train the model.

A training component of a remote computing device, such as the computing device(s) 434 (not shown) and/or the vehicle computing device(s) 404 (not shown) may be implemented to train the guidance component 206 (in examples when the guidance component 206 is a machine learned model). Training data may include a wide variety of data, such as previous token data (e.g., a map token and/or image token for a scene), log data (e.g., instances when a remote operator provided a response or solution (or data associated therewith such as solution data) to a request for assistance or otherwise guided a vehicle), historical data, historical data input into the model(s) 208, image data, video data, lidar data, radar data, audio data, other sensor data, data transmitted from the autonomous vehicle 202, etc., that is associated with a value (e.g., a desired classification, inference, prediction, etc.). In some examples training data can comprise determinations by a human (e.g., how a human driver responds to the event, etc.), a cost based on how the autonomous vehicle operates based on the output data 212 (in examples when the output data is transmitted to the autonomous vehicle), etc. The training data may also include determinations based on sensor data, such as bounding boxes (e.g., two-dimensional and/or three-dimensional bounding boxes associated with an object), segmentation information, classification information, an object trajectory, an object probability, object track information, and the like. Such training data may generally be referred to as a “ground truth.” To illustrate, the training data may be used for image classification and, as such, may include an image of an environment that is captured by an autonomous vehicle and that is associated with one or more classifications. In some examples, such a classification may be based on user input (e.g., user input indicating that the image depicts a specific type of object) or may be based on the output of another machine learned model. In some examples, such labeled classifications (or more generally, the labeled output associated with training data) may be referred to as ground truth.

By way of example and not limitation, the training component can train a large language model based at least in part on a pre-trained large language model and adding vision capabilities using an image model. For example, a pre-trained large language model can be combined with an image model that is trained to understand scenes associated with an autonomous vehicle in an environment. The large language model can, for instance, be trained to determine text that accurately describes a scene with respect to driving (e.g., an action by the autonomous vehicle). Training data can include scene information associated with different types of interventions by a remote operator at a previous time that can be structured as text. A reward model may be used in some examples to determine how well the autonomous vehicle operates in the environment using the output data (e.g., a good or bad description).

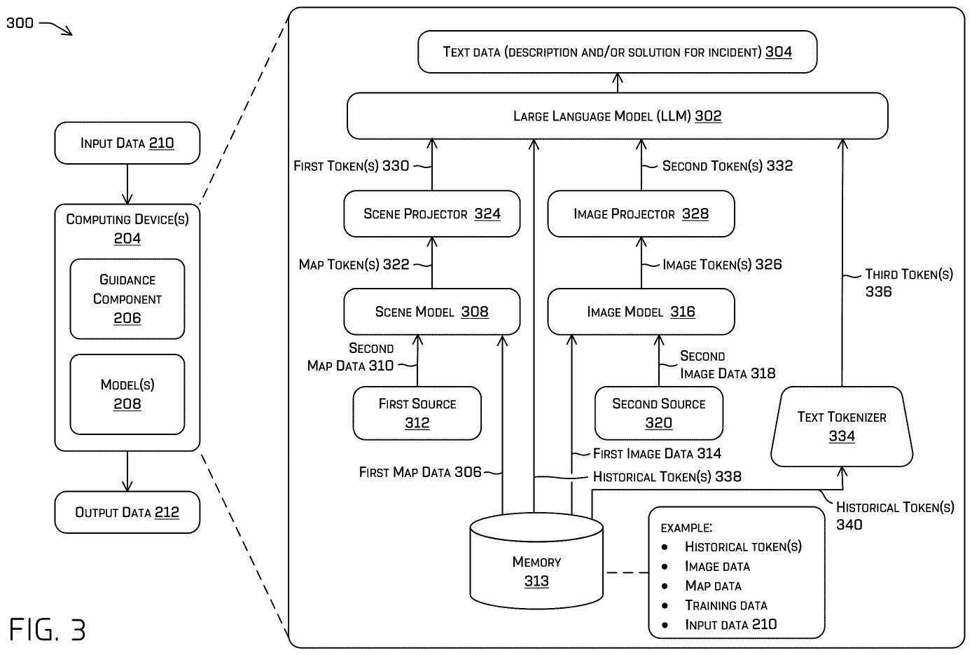

FIG. 3 illustrates an example block diagram 300 of an example computing architecture for implementing techniques to determine guidance for an autonomous vehicle, as described herein. For instance, the computing device(s) 204 can include a large language model 302 for determining the output data 212 (also shown as text data 304) based at least in part on receiving the input data 210 as input. In example when the large language model 302 received input data in at least two different modalities (e.g., text, image, video, etc.), the large language model 302 can represent a multimodal large language model.

In some examples, the large language model 302 can output the text data 304 (as the output data 212) indicative of a description and/or a solution for an event (e.g., the event 218) proximate an autonomous vehicle (e.g., a threshold distance from the autonomous vehicle 202). For example, the text data 304 can include text for the autonomous vehicle 202 to move into a particular lane, to yield to an object, to not yield to an object, to proceed at an intersection, to go around a construction zone, etc. By way of example and not limitation, the text data 304 can include one or more waypoints that can direct the autonomous vehicle 202 to a position in a coordinate system of an environment (e.g., a first waypoint, a second waypoint, etc.). For example, the autonomous vehicle 202 can translate the waypoints (e.g., using java script object notation (JSON) or another data format) received as text from the computing device(s) 204. In some examples, the vehicle computing device(s) 226 can call a function to interpret the text received as guidance from the computing device(s) 204. The text data 304 may also or instead describe an event or scenario such as “there is a flagger at <bonding box identifier>”.

FIG. 3 depicts a memory 313 (e.g., the database 214, a memory associated with a server or otherwise remote from the autonomous vehicle 202, a memory coupled to the autonomous vehicle 202, or the like) providing first map data 306 to a scene model 308. The scene model 308 can also or instead receive second map data 310 from a first source 312. In various examples, the memory 313 can also or instead provide first image data 314 (e.g., historical image tokens) to an image model 316. The image model 316 can receive, in some examples, second image data 318 from a second source 320. The first image data 314 or the second image data 318 can represent an image provided by the autonomous vehicle 202, or an image processed based on sensor data from the autonomous vehicle (e.g., a bird's eye view, top-down perspective, vector representations, or the like). The first source 312 or the second source 320 can represent the autonomous vehicle 202, another vehicle in a same fleet of vehicles as the autonomous vehicle, the memory 313, to name a few.

In examples, the scene model 308 can output one or more map token(s) 322 to be received by a scene projector 324. In various examples, the image model 316 can output one or more image tokens 326 to be received by the image projector 328 (e.g., a multilayer perceptron or other model). The image projector 328 can map the image token(s) 326 and/or historical image token(s) into a representational space usable for processing by a large language model 302 (LLM). In some examples, the scene projector 324 can representing a behavior projector and the scene model 308 can represent a behavior model or encoder. The scene projector 324 can, for example, represent a behavior projector for one or more objects proximate the autonomous vehicle 202. The scene model 308 can be configured to interpret of define the structured data associated with the environment (e.g., map data or other data used as input). In various examples, the image model 316 can represent a contrastive language-image pretraining (CLIP) model (e.g., a pretrained CLIP encoder) that receives image data as input.

In various examples, the scene projector 324 can output one or more first tokens 330 as a first input into the large language model 302 and the image projector 328 can output one or more second tokens 332 as a second input into the large language model 302. Additionally, or alternatively, a text tokenizer 334 can output one or more third tokens 336 as a third input into the large language model 302. The third token(s) 336 can represent a token for text indicating a condition or prompt for the large language model 302 to follow such as “you are an operator of a vehicle” and/or “tell me what the vehicle should do in this scenario,” or similar to prompt the functionality of the large language model 302 to determine the text data 304 (e.g., identify a description and/or generate a solution for an event). In some examples, the text tokenizer 334 can represent a byte-pair encoding (BPE) tokenizer that receives text data as input and determine one or more tokens (e.g., the third token(s) 336) to represent the text data. The third token(s) 336 from the text tokenizer 334 can indicate how the large language model 302 is to process the first token(s) 330 and the second token(s) 332, for example. Using the third token(s) 336 can save time and/or an amount of training data for training the large language model 302.

By way of example and not limitation, the scene model 308 can receive the first map data 306 and/or the second map data 310 associated with a scenario in a real-world environment in which a hotel representative is attempting to direct the autonomous vehicle 202. The second map data 310 can identify a bounding box for the hotel representative and other objects in the environment, when present. The image model 316 can receive image data from the autonomous vehicle 202 and/or from the memory 313. For example, the autonomous vehicle 202 can send image data to the memory 313 and/or to the image model 316 for processing, and the image model 316 can receive the second image data 318 to output the image token(s) 326 describing a vicinity of the autonomous vehicle 202. The image token(s) 326 can be output to the image projector 328 to determine an embedding of the second token(s) for processing by the large language model 302. The scene projector 324 can provide another embedding for the first token(s) 330 having a same size as the embedding of the second token(s) 332 to represent map features and/or scene features such as object behavior(s) of an object(s) for processing by the large language model 302. In such examples, the large language model 302 can output the text data 304 to indicate that the autonomous vehicle does not understand the hotel representative (e.g.,, a description) and to request that the vehicle make a turn, change lanes, proceed, yield, etc. to cause the autonomous vehicle 202 to navigate relative to the hotel representative.

Using the memory 313 to provide historical tokens or data as input to a respective model or projector, can improve efficiency by the large language model 302 to generate the output data 212 (e.g., to reduce an amount of time to generate the text data 304). For example, a token for a previous image frame, map feature, scene, etc. can be stored in the memory 313 and used to minimize a number of computations and/or computational resources required to generate the text data 304. For example, the large language model 302 can retrieve one or more historical tokens 338 from the memory 313. In some examples, one or more historical tokens 340 (e.g., a sentence token describing a scene, an event, or a solution to the event) can be provided by the memory 313 to the text tokenizer 334 and/or to the large language model 302. The historical token(s) 338 or the historical token(s) 340 can represent a map token, scene token, image token, sentence token, text token (other than a sentence), to name a few.

In various examples, the image projector 328 can be trained to map image tokens into a representation space usable by the large language model 302. For example, a large language and visual assistant (LLaVa) technique can be used, to tune or train the large language model 302, though other techniques may also or instead be implemented.

The large language model 302 can, for example, be implemented to receive and/or output text in the form of a question and/or answer to act as a “chatting” interface between the vehicle computing device and the computing device(s) 204 (or a remote operator associated therewith).

The inputs depicted in FIG. 3 are not limited to the arrows expressly shown and any of the data from the memory 313, the first source 312, or the second source 320 can go into any of the models, projectors, or components as input data.

FIG. 4 is a block diagram of an example system 400 for implementing the techniques described herein. In at least one example, the system 400 may include a vehicle, such as vehicle 402.

The vehicle 402 may include one or more vehicle computing devices 404, one or more sensor systems 406, one or more emitters 408, one or more communication connections 410, at least one direct connection 412, and one or more drive system(s) 414.

The vehicle computing device(s) 404 may include one or more processors 416 and memory 418 communicatively coupled with the one or more processors 416. In the illustrated example, the vehicle 402 is an autonomous vehicle; however, the vehicle 402 could be any other type of vehicle, such as a semi-autonomous vehicle, or any other system having at least an image capture device (e.g., a camera enabled smartphone). In some instances, the autonomous vehicle 402 may be an autonomous vehicle configured to operate according to a Level 5 classification issued by the U.S. National Highway Traffic Safety Administration, which describes a vehicle capable of performing all safety-critical functions for the entire trip, with the driver (or occupant) not being expected to control the vehicle at any time. However, in other examples, the autonomous vehicle 402 may be a fully or partially autonomous vehicle having any other level or classification.

In various examples, the vehicle computing device(s) 404 may store sensor data associated with actual location of an object at the end of the set of estimated states (e.g., end of the period of time) and may use this data as training data to train one or more models. In some examples, the vehicle computing device(s) 404 may provide the data to a remote computing device (i.e., computing device separate from vehicle computing device such as one or more computing device(s) 434) for data analysis. In such examples, the remote computing device(s) may analyze the sensor data to determine an actual location, velocity, direction of travel, or the like of the object at the end of the set of estimated states. Additional details of training a machine learned model based on stored sensor data by minimizing differences between actual and predicted positions and/or predicted trajectories is described in U.S. patent application Ser. No. 16/282,201, filed on Mar. 12, 2019, entitled “Motion Prediction Based on Appearance,” which is incorporated herein by reference in its entirety and for all purposes.

In the illustrated example, the memory 418 of the vehicle computing device(s) 404 stores a localization component 420, a perception component 422, a planning component 424, one or more system controllers 426, one or more maps 428, and a model component 430 including one or more model(s), such as a first model 432A, a second model 432B, up to an Nth model 432N (collectively “models 432”), where N is an integer. Though depicted in FIG. 4 as residing in the memory 418 for illustrative purposes, it is contemplated that the localization component 420, a perception component 422, a planning component 424, one or more system controllers 426, one or more maps 428, and/or the model component 430 including the model(s) 432 may additionally, or alternatively, be accessible to the vehicle 402 (e.g., stored on, or otherwise accessible by, memory remote from the vehicle 402, such as, for example, on memory 438 of the computing device(s) 434). In some examples, the model(s) 432 can provide functionality associated with the guidance component 206 and/or the model(s) 208. In some examples, the model(s) 432 can include one or more of: a machine learned model, a statistical model, a heuristic model, or a combination thereof.

In at least one example, the localization component 420 may include functionality to receive data from the sensor system(s) 406 to determine a position and/or orientation of the vehicle 402 (e.g., one or more of an x-, y-, z-position, roll, pitch, or yaw). For example, the localization component 420 may include and/or request/receive a map of an environment, such as from map(s) 428 and/or map component 444, and may continuously determine a location and/or orientation of the autonomous vehicle within the map. In some instances, the localization component 420 may utilize SLAM (simultaneous localization and mapping), CLAMS (calibration, localization and mapping, simultaneously), relative SLAM, bundle adjustment, non-linear least squares optimization, or the like to receive image data, lidar data, radar data, IMU data, GPS data, wheel encoder data, and the like to accurately determine a location of the autonomous vehicle. In some instances, the localization component 420 may provide data to various components of the vehicle 402 to determine an initial position of an autonomous vehicle for determining the relevance of an object to the vehicle 402, as discussed herein.

In some instances, the perception component 422 may include functionality to perform object detection, segmentation, and/or classification. In some examples, the perception component 422 may provide processed sensor data that indicates a presence of an object (e.g., entity) that is proximate to the vehicle 402 and/or a classification of the object as an object type (e.g., car, pedestrian, cyclist, animal, building, tree, road surface, curb, sidewalk, unknown, etc.). In some examples, the perception component 422 may provide processed sensor data that indicates a presence of a stationary entity that is proximate to the vehicle 402 and/or a classification of the stationary entity as a type (e.g., building, tree, road surface, curb, sidewalk, unknown, etc.). In additional or alternative examples, the perception component 422 may provide processed sensor data that indicates one or more features associated with a detected object (e.g., a tracked object) and/or the environment in which the object is positioned. In some examples, features associated with an object may include, but are not limited to, an x-position (global and/or local position), a y-position (global and/or local position), a z-position (global and/or local position), an orientation (e.g., a roll, pitch, yaw), an object type (e.g., a classification), a velocity of the object, an acceleration of the object, an extent of the object (size), etc. Features associated with the environment may include, but are not limited to, a presence of another object in the environment, a state of another object in the environment, a time of day, a day of a week, a season, a weather condition, an indication of darkness/light, etc.

In general, the planning component 424 may determine a path for the vehicle 402 to follow to traverse through an environment. For example, the planning component 424 may determine various routes and trajectories and various levels of detail. For example, the planning component 424 may determine a route to travel from a first location (e.g., a current location) to a second location (e.g., a target location). For the purpose of this discussion, a route may include a sequence of waypoints for travelling between two locations. As non-limiting examples, waypoints include streets, intersections, global positioning system (GPS) coordinates, etc. Further, the planning component 424 may generate an instruction for guiding the autonomous vehicle along at least a portion of the route from the first location to the second location. In at least one example, the planning component 424 may determine how to guide the autonomous vehicle from a first waypoint in the sequence of waypoints to a second waypoint in the sequence of waypoints. In some examples, the instruction may be a trajectory, or a portion of a trajectory. In some examples, multiple trajectories may be substantially simultaneously generated (e.g., within technical tolerances) in accordance with a receding horizon technique, wherein one of the multiple trajectories is selected for the vehicle 402 to navigate.

In some examples, the planning component 424 may include a prediction component to generate predicted trajectories of objects (e.g., objects) in an environment and/or to generate predicted candidate trajectories for the vehicle 402. For example, a prediction component may generate one or more predicted trajectories for objects within a threshold distance from the vehicle 402. In some examples, a prediction component may measure a trace of an object and generate a trajectory for the object based on observed and predicted behavior.

In at least one example, the vehicle computing device(s) 404 may include one or more system controllers 426, which may be configured to control steering, propulsion, braking, safety, emitters, communication, and other systems of the vehicle 402. The system controller(s) 426 may communicate with and/or control corresponding systems of the drive system(s) 414 and/or other components of the vehicle 402.

The memory 418 may further include one or more maps 428 that may be used by the vehicle 402 to navigate within the environment. For the purpose of this discussion, a map may be any number of data structures modeled in two dimensions, three dimensions, or N-dimensions that are capable of providing information about an environment, such as, but not limited to, topologies (such as intersections), streets, mountain ranges, roads, terrain, and the environment in general. In some instances, a map may include, but is not limited to: texture information (e.g., color information (e.g., RGB color information, Lab color information, HSV/HSL color information), and the like), intensity information (e.g., lidar information, radar information, and the like); spatial information (e.g., image data projected onto a mesh, individual “surfels” (e.g., polygons associated with individual color and/or intensity)), reflectivity information (e.g., specularity information, retroreflectivity information, BRDF information, BSSRDF information, and the like). In one example, a map may include a three-dimensional mesh of the environment. In some examples, the vehicle 402 may be controlled based at least in part on the map(s) 428. That is, the map(s) 428 may be used in connection with the localization component 420, the perception component 422, and/or the planning component 424 to determine a location of the vehicle 402, detect objects in an environment, generate routes, determine actions and/or trajectories to navigate within an environment.

In some examples, the one or more maps 428 may be stored on a remote computing device(s) (such as the computing device(s) 434) accessible via one or more networks 440. In some examples, multiple maps 428 may be stored based on, for example, a characteristic (e.g., type of entity, time of day, day of week, season of the year, etc.). Storing multiple maps 428 may have similar memory requirements, but increase the speed at which data in a map may be accessed.

As illustrated in FIG. 4, the vehicle computing device(s) 404 may include a model component 430. The model component 430 may be configured to perform the functionality of the guidance component 206 including predicting text associated with an object or an event in an environment. In various examples, the model component 430 may receive one or more features associated with the detected object(s) from the perception component 422 and/or from the sensor system(s) 406. In some examples, the model component 430 may receive environment characteristics (e.g., environmental factors, etc.) and/or weather characteristics (e.g., weather factors such as snow, rain, ice, etc.) from the perception component 422 and/or the sensor system(s) 406. While shown separately in FIG. 4, the model component 430 could be part of the planning component 424 or other component(s) of the vehicle 402.

In various examples, the model component 430 may send predictions from the one or more models 432 (e.g., the model(s) 208) that may be used by the planning component 424 to generate one or more predicted trajectories of the object (e.g., direction of travel, speed, etc.) and/or one or more predicted trajectories of the object (e.g., direction of travel, speed, etc.), such as from the prediction component thereof. In some examples, the planning component 424 may determine one or more actions (e.g., reference actions and/or sub-actions) for the vehicle 402, such as vehicle candidate trajectories. In some examples, the model component 430 may be configured to determine text indicating whether an object occupies a future position based at least in part on the one or more actions for the vehicle 402. In some examples, the model component 430 may be configured to determine the future positions that are applicable to the environment, such as based on environment characteristics, weather characteristics, another object, or the like.

The model component 430 may generate or otherwise be associated with sets of estimated states of the vehicle and one or more detected objects forward in the environment over a time period. The model component 430 may generate a set of estimated states for each action (e.g., reference action and/or sub-action) determined to be applicable to the environment. The sets of estimated states may include one or more estimated states, each estimated state including an estimated position of the vehicle and an estimated position of a detected object(s). In some examples, the estimated states may include estimated positions of the detected objects at an initial time (T =0) (e.g., current time).

The estimated positions may be determined based on a detected trajectory and/or predicted trajectories associated with the object. In some examples, the estimated positions may be determined based on an assumption of substantially constant velocity and/or substantially constant trajectory (e.g., little to no lateral movement of the object). In some examples, the estimated positions (and/or potential trajectories) may be based on passive and/or active prediction. In some examples, the model component 430 may utilize physics and/or geometry-based techniques, machine learning, linear temporal logic, tree search methods, heat maps, and/or other techniques for determining predicted trajectories and/or estimated positions of objects.

In various examples, the estimated states may be generated periodically throughout the time period. For example, the model component 430 may generate estimated states at 0.1 second intervals throughout the time period. For another example, the model component 430 may generate estimated states at 0.05 second intervals. The estimated states may be used by the planning component 424 in determining an action for the vehicle 402 to take in an environment.

In various examples, the model component 430 may utilize machine learned techniques to predict text information, object positions, vehicle positions, and so on. In such examples, the machine learned algorithms may be trained to determine, based on sensor data and/or previous predictions by the model, that an object is likely to behave in a particular way relative to the vehicle 402 at a particular time during a set of estimated states (e.g., time period). In such examples, one or more of the vehicle 402 state (position, velocity, acceleration, trajectory, etc.) and/or the object state, classification, etc. may be input into such a machine learned model and, in turn, a trajectory prediction may be output by the model.

In various examples, characteristics associated with each object type may be used by the model component 430 to determine text indicative of a position, a trajectory, a velocity, or an acceleration associated with the object. Examples of characteristics of an object type may include, but not be limited to: a maximum longitudinal acceleration, a maximum lateral acceleration, a maximum vertical acceleration, a maximum speed, maximum change in direction for a given speed, and the like.

As can be understood, the components discussed herein (e.g., the localization component 420, the perception component 422, the planning component 424, the system controller(s) 426, the one or more maps 428, the model component 430 including the model(s) 432 are described as divided for illustrative purposes. However, the operations performed by the various components may be combined or performed in any other component.

While examples are given in which the techniques described herein are implemented by a planning component and/or a model component of the vehicle, in some examples, some or all of the techniques described herein could be implemented by another system of the vehicle, such as a secondary safety system. Generally, such an architecture can include a first computing device to control the vehicle 402 and a secondary safety system that operates on the vehicle 402 to validate operation of the primary system and to control the vehicle 402 to avoid collisions.

In some instances, aspects of some or all of the components discussed herein may include any models, techniques, and/or machine learned techniques. For example, in some instances, the components in the memory 418 (and the memory 438, discussed below) may be implemented as a neural network.

As described herein, an exemplary neural network is a technique which passes input data through a series of connected layers to produce an output. Each layer in a neural network may also comprise another neural network, or may comprise any number of layers (whether convolutional or not). As can be understood in the context of this disclosure, a neural network may utilize machine learning, which may refer to a broad class of such techniques in which an output is generated based on learned parameters.

Although discussed in the context of neural networks, any type of machine learning may be used consistent with this disclosure. For example, machine learning techniques may include, but are not limited to, regression techniques (e.g., ordinary least squares regression (OLSR), linear regression, logistic regression, stepwise regression, multivariate adaptive regression splines (MARS), locally estimated scatterplot smoothing (LOESS)), instance-based techniques (e.g., ridge regression, least absolute shrinkage and selection operator (LASSO), elastic net, least-angle regression (LARS)), decisions tree techniques (e.g., classification and regression tree (CART), iterative dichotomiser 3 (ID3), Chi-squared automatic interaction detection (CHAID), decision stump, conditional decision trees), Bayesian techniques (e.g., naïve Bayes, Gaussian naïve Bayes, multinomial naïve Bayes, average one-dependence estimators (AODE), Bayesian belief network (BNN), Bayesian networks), clustering techniques (e.g., k-means, k-medians, expectation maximization (EM), hierarchical clustering), association rule learning techniques (e.g., perceptron, back-propagation, hopfield network, Radial Basis Function Network (RBFN)), deep learning techniques (e.g., Deep Boltzmann Machine (DBM), Deep Belief Networks (DBN), Convolutional Neural Network (CNN), Stacked Auto-Encoders), Dimensionality Reduction Techniques (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Techniques (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like.

In at least one example, the sensor system(s) 406 may include lidar sensors, radar sensors, ultrasonic transducers, sonar sensors, location sensors (e.g., GPS, compass, etc.), inertial sensors (e.g., inertial measurement units (IMUs), accelerometers, magnetometers, gyroscopes, etc.), cameras (e.g., RGB, IR, intensity, depth, time of flight, etc.), microphones, wheel encoders, environment sensors (e.g., temperature sensors, humidity sensors, light sensors, pressure sensors, etc.), etc. The sensor system(s) 406 may include multiple instances of each of these or other types of sensors. For instance, the lidar sensors may include individual lidar sensors located at the corners, front, back, sides, and/or top of the vehicle 402. As another example, the camera sensors may include multiple cameras disposed at various locations about the exterior and/or interior of the vehicle 402. The sensor system(s) 406 may provide input to the vehicle computing device(s) 404. Additionally, or in the alternative, the sensor system(s) 406 may send sensor data, via the one or more networks 440, to the computing device(s) 434 at a particular frequency, after a lapse of a predetermined period of time, in near real-time, etc.

The vehicle 402 may also include the one or more emitters 408 for emitting light and/or sound. The emitter(s) 408 may include interior audio and visual emitters to communicate with passengers of the vehicle 402. By way of example and not limitation, interior emitters may include speakers, lights, signs, display screens, touch screens, haptic emitters (e.g., vibration and/or force feedback), mechanical actuators (e.g., seatbelt tensioners, seat positioners, headrest positioners, etc.), and the like. The emitter(s) 408 may also include exterior emitters. By way of example and not limitation, the exterior emitters may include lights to signal a direction of travel or other indicator of vehicle action (e.g., indicator lights, signs, light arrays, etc.), and one or more audio emitters (e.g., speakers, speaker arrays, horns, etc.) to audibly communicate with pedestrians or other nearby vehicles, one or more of which comprising acoustic beam steering technology.

The vehicle 402 may also include one or more communication connections 410 that enable communication between the vehicle 402 and one or more other local or remote computing device(s). For instance, the communication connection(s) 410 may facilitate communication with other local computing device(s) on the vehicle 402 and/or the drive system(s) 414. Also, the communication connection(s) 410 may allow the vehicle to communicate with other nearby computing device(s) (e.g., the computing device(s) 434, other nearby vehicles, etc.) and/or one or more remote sensor system(s) 442 for receiving sensor data. The communications connection(s) 410 also enable the vehicle 402 to communicate with a remote teleoperations computing device or other remote services.

The communications connection(s) 410 may include physical and/or logical interfaces for connecting the vehicle computing device(s) 404 to another computing device or a network, such as the network(s) 440. For example, the communications connection(s) 410 can enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.) or any suitable wired or wireless communications protocol that enables the respective computing device to interface with the other computing device(s).

As mentioned, the vehicle 402 may include one or more drive systems 414. In some examples, the vehicle 402 may have a single drive system 414. In at least one example, if the vehicle 402 has multiple drive systems 414, individual drive systems 414 may be positioned on opposite ends of the vehicle 402 (e.g., the front and the rear, etc.). In at least one example, the drive system(s) 414 may include one or more sensor systems to detect conditions of the drive system(s) 414 and/or the surroundings of the vehicle 402. By way of example and not limitation, the sensor system(s) may include one or more wheel encoders (e.g., rotary encoders) to sense rotation of the wheels of the drive modules, inertial sensors (e.g., inertial measurement units, accelerometers, gyroscopes, magnetometers, etc.) to measure orientation and acceleration of the drive module, cameras or other image sensors, ultrasonic sensors to acoustically detect objects in the surroundings of the drive module, lidar sensors, radar sensors, etc. Some sensors, such as the wheel encoders may be unique to the drive system(s) 414. In some cases, the sensor system(s) on the drive system(s) 414 may overlap or supplement corresponding systems of the vehicle 402 (e.g., sensor system(s) 406).

The drive system(s) 414 may include many of the vehicle systems, including a high voltage battery, a motor to propel the vehicle, an inverter to convert direct current from the battery into alternating current for use by other vehicle systems, a steering system including a steering motor and steering rack (which can be electric), a braking system including hydraulic or electric actuators, a suspension system including hydraulic and/or pneumatic components, a stability control system for distributing brake forces to mitigate loss of traction and maintain control, an HVAC system, lighting (e.g., lighting such as head/tail lights to illuminate an exterior surrounding of the vehicle), and one or more other systems (e.g., cooling system, safety systems, onboard charging system, other electrical components such as a DC/DC converter, a high voltage junction, a high voltage cable, charging system, charge port, etc.). Additionally, the drive system(s) 414 may include a drive system controller which may receive and preprocess data from the sensor system(s) and to control operation of the various vehicle systems. In some examples, the drive system controller may include one or more processors and memory communicatively coupled with the one or more processors. The memory may store one or more modules to perform various functionalities of the drive system(s) 414. Furthermore, the drive system(s) 414 may also include one or more communication connection(s) that enable communication by the respective drive system with one or more other local or remote computing device(s).

In at least one example, the direct connection 412 may provide a physical interface to couple the one or more drive system(s) 414 with the body of the vehicle 402. For example, the direct connection 412 may allow the transfer of energy, fluids, air, data, etc. between the drive system(s) 414 and the vehicle. In some instances, the direct connection 412 may further releasably secure the drive system(s) 414 to the body of the vehicle 402.

In at least one example, the localization component 420, the perception component 422, the planning component 424, the system controller(s) 426, the one or more maps 428, and the model component 430, may process sensor data, as described above, and may send their respective outputs, over the network(s) 440, to the computing device(s) 434. In at least one example, the localization component 420, the perception component 422, the planning component 424, the system controller(s) 426, the one or more maps 428, and the model component 430 may send their respective outputs to the computing device(s) 434 at a particular frequency, after a lapse of a predetermined period of time, in near real-time, etc.

In some examples, the vehicle 402 may send sensor data to the computing device(s) 434 via the network(s) 440. In some examples, the vehicle 402 may receive sensor data from the computing device(s) 434 and/or remote sensor system(s) 442 via the network(s) 440. The sensor data may include raw sensor data and/or processed sensor data and/or representations of sensor data. In some examples, the sensor data (raw or processed) may be sent and/or received as one or more log files.

The computing device(s) 434 may include processor(s) 436 and a memory 438 storing the map component 444, a sensor data processing component 446, and a training component 448. In some examples, the map component 444 may include functionality to generate maps of various resolutions. In such examples, the map component 444 may send one or more maps to the vehicle computing device(s) 404 for navigational purposes. In various examples, the sensor data processing component 446 may be configured to receive data from one or more remote sensors, such as sensor system(s) 406 and/or remote sensor system(s) 442. In some examples, the sensor data processing component 446 may be configured to process the data and send processed sensor data to the vehicle computing device(s) 404, such as for use by the model component 430 (e.g., the model(s) 432). In some examples, the sensor data processing component 446 may be configured to send raw sensor data to the vehicle computing device 404.

In some instances, the training component 448 can include functionality to train a machine learning model to output text describing or solving an event. For example, the training component 448 can receive sensor data that represents an object traversing through an environment for a period of time, such as 0.1 milliseconds, 1 second, 3, seconds, 5 seconds, 7 seconds, and the like. At least a portion of the sensor data can be used as an input to train the machine learning model.

In some instances, the training component 448 may be executed by the processor(s) 436 to train a machine learning model based on training data. The training data may include a wide variety of data, such as sensor data, audio data, image data, map data, inertia data, vehicle state data, historical data (log data), or a combination thereof, that is associated with a value (e.g., a desired classification, inference, prediction, etc.). Such values may generally be referred to as a “ground truth.” To illustrate, the training data may be used for determining risk associated with occluded regions and, as such, may include data representing an environment that is captured by an autonomous vehicle and that is associated with one or more classifications or determinations. In some examples, such a classification may be based on user input (e.g., user input indicating that the data depicts a specific risk) or may be based on the output of another machine learned model. In some examples, such labeled classifications (or more generally, the labeled output associated with training data) may be referred to as ground truth.

In some instances, the training component 448 can include functionality to train a machine learning model to output classification values. For example, the training component 448 can receive data that represents labelled collision data (e.g. publicly available data, sensor data, and/or a combination thereof). At least a portion of the data can be used as an input to train the machine learning model. Thus, by providing data where the vehicle traverses an environment, the training component 448 can be trained to output occluded value(s) associated with objects and/or occluded region(s), as discussed herein.

In some examples, the training component 448 can include training data that has been generated by a simulator. For example, simulated training data can represent examples where a vehicle collides with an object in an environment or nearly collides with an object in an environment, to provide additional training examples.

The processor(s) 416 of the vehicle 402 and the processor(s) 436 of the computing device(s) 434 may be any suitable processor capable of executing instructions to process data and perform operations as described herein. By way of example and not limitation, the processor(s) 416 and 436 may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

Memory 418 and memory 438 are examples of non-transitory computer-readable media. The memory 418 and memory 438 may store an operating system and one or more software applications, instructions, programs, and/or data to implement the methods described herein and the functions attributed to the various systems. In various implementations, the memory may be implemented using any suitable memory technology, such as static random access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

It should be noted that while FIG. 4 is illustrated as a distributed system, in alternative examples, components of the vehicle 402 may be associated with the computing device(s) 434 and/or components of the computing device(s) 434 may be associated with the vehicle 402. That is, the vehicle 402 may perform one or more of the functions associated with the computing device(s) 434, and vice versa.

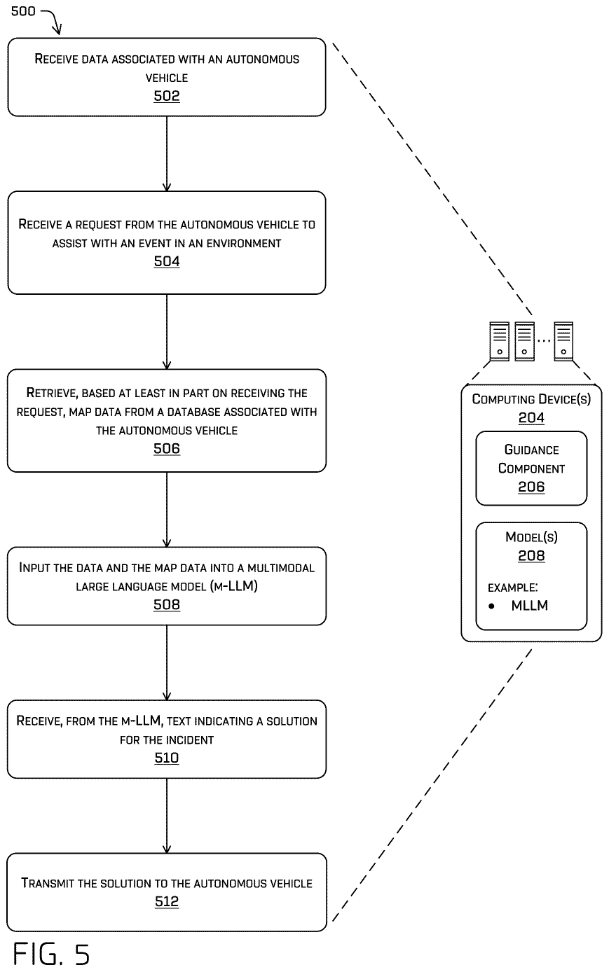

FIG. 5 is a flowchart depicting an example process 500 for determining text for guiding an autonomous vehicle relative to an event using an example multimodal large language model. Some or all of the process 500 may be performed by one or more components in FIGS. 1-4, as described herein. For example, some or all of the process 500 can be performed by the remote computing device(s) 114, the computing device(s) 204, the vehicle computing device(s) 226, the vehicle computing device(s) 404, or the computing device(s) 434.

At operation 502, the process may include receiving data associated with an autonomous vehicle. In some examples, the operation 502 may include the computing device(s) 204 implementing the guidance component 206 to receive sensor data, map data, and/or planner data associated with an event (e.g., the event 218) from the autonomous vehicle 202. The computing device(s) 204 may also or instead receive prediction data, state data, log data, route information, lane occupancy information, and/or environment data associated with the event 218. In some examples, the sensor data can be associated with a feature vector or a top-down view of an environment from a machine learned model.

At operation 504, the process may include receiving a request from the autonomous vehicle to assist with an event in an environment. In some examples, the operation 504 may include the guidance component 206 receiving a message from the autonomous vehicle 202 over the network(s) 216. The computing device(s) 204 may also receive, in the request, prediction data, map data, state data, log data, sensor data, route information, lane occupancy information, and/or environment data associated with the autonomous vehicle 202.

At operation 506, the process may include retrieving, based at least in part on receiving the request, map data from a database associated with the autonomous vehicle, the map data describing a region of the environment a threshold distance from the autonomous vehicle. In some examples, the operation 506 may include the map(s) 428 and/or the planning component 424 of the vehicle computing device(s) 404 transmitting map data associated with an environment (e.g., a threshold distance from the autonomous vehicle 202) to a database (e.g., the database 214) at periodic times, and the guidance component 206 can access the map data responsive to receiving the request for assistance. In some examples, the map data can include features of a real-world environment and/or a simulated environment. In various examples, the map data can be associated with previous navigation by the autonomous vehicle 202 and/or another autonomous vehicle in a fleet of vehicle in the real-world environment and/or a previous simulation in the simulated environment

At operation 508, the process may include inputting the data and the map data into a multimodal large language model (MLLM). In some examples, the operation 508 may include the model(s) 208 receiving map data, image data, video data, object data associated with one or more objects, or the like as part of the input data 210.

At operation 510, the process may include receiving, from the MLLM, text indicating a solution for the event. In some examples, the operation 510 may include the model(s) 208 receiving text from the text tokenizer 334 describing a condition for the MLLM (e.g., to provide a solution to the event, answer a text question received from the autonomous vehicle, define a question associated with the event, etc.). The first text can represent a description of the event usable by the autonomous vehicle and/or a remote operator. In some examples, the operation 510 may include the model(s) 208 outputting the output data 212 indicating text describing a solution for the autonomous vehicle 202 to navigate relative to the event 218.

At operation 512, the process may include transmitting the solution to the autonomous vehicle. In some examples, the operation 512 may include the computing device(s) 204 transmitting text data to the vehicle computing device(s) 226 associated with the autonomous vehicle 202. The transmitted data can, for example, be configured to cause a planning component (e.g., the planning component 232 or the planning component 424) of the autonomous vehicle to determine a trajectory to navigate the autonomous vehicle in the environment.

In some examples, the operation 512 may include the planning component 424 of the vehicle computing device(s) 404 controlling operation of the vehicle 402 based at least in part on the solution 122 associated with the event 218. In some examples, the planning component 424 can output one or more candidate trajectories for the vehicle 402 to use to avoid the event 218 or a blocked region associated with therewith (e.g., the blocked region 222), to avoid a collision with an object (e.g., the object 224).

In various examples, process 500 may return to the operation 502 after performing operation 512. In such examples, the vehicle may continuously monitor for potential collisions and update/modify decisions regarding whether to engage a safety system or not (which may, in at least some examples, include performing one or more maneuvers to mitigate or minimize an impact). In any of the examples described herein, the process may repeat with a given frequency and generate one or more probability values associated with one or more objects at multiple times in the future for making the determinations above.

FIG. 5 illustrates an example process in accordance with examples of the disclosure. The process is illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes. In some embodiments, one or more operations of the method may be omitted entirely. By way of example and not limitation, operations 504, 506, 508, and 510 may be performed while performing operation 512. Moreover, the methods described herein can be combined in whole or in part with each other or with other methods.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be omitted or combined in any order and/or in parallel to implement the processes.

The various techniques described herein may be implemented in the context of computer-executable instructions or software, such as program modules, that are stored in computer-readable storage and executed by the processor(s) of one or more computing devices such as those illustrated in the figures. Generally, program modules include routines, programs, objects, components, data structures, etc., and define operating logic for performing particular tasks or implement particular abstract data types.

Other architectures may be used to implement the described functionality and are intended to be within the scope of this disclosure. Furthermore, although specific distributions of responsibilities are defined above for purposes of discussion, the various functions and responsibilities might be distributed and divided in different ways, depending on circumstances.

Similarly, software may be stored and distributed in various ways and using different means, and the particular software storage and execution configurations described above may be varied in many different ways. Thus, software implementing the techniques described above may be distributed on various types of computer-readable media, not limited to the forms of memory that are specifically described.

### EXAMPLE CLAUSES

Any of the example clauses in this section may be used with any other of the example clauses and/or any of the other examples or embodiments described herein.

A: A system comprising: one or more processors; and one or more non-transitory computer-readable media storing instructions executable by the one or more processors, wherein the instructions, when executed, cause the system to perform operations comprising: receiving data associated with an autonomous vehicle; receiving a request from the autonomous vehicle to assist with an event in an environment; retrieving, based at least in part on receiving the request, map data from a database associated with the autonomous vehicle, the map data describing a region of the environment within a threshold distance from the autonomous vehicle; inputting the data and the map data into a multimodal large language model (MLLM); receiving, from the MLLM, text indicating a solution for the event; and transmitting the solution to the autonomous vehicle, wherein the solution is configured to cause a planning component of the autonomous vehicle to determine a trajectory to navigate the autonomous vehicle in the environment.

B: The system of paragraph A, wherein the data comprises a first portion structured as image data, and the operations further comprising: inputting the image data into an image model; inputting the map data into a scene model; receiving first output data from the image model; receiving second output data from the scene model; and inputting, as input data, the first output data and the second output data into the MLLM.

C: The system of paragraph B, wherein inputting the input data comprises: inputting the first output data into a first projector; receiving, from the first projector, a first common representation; inputting the second output data into a second projector; receiving from the second projector, a second common representation; and inputting the first common representation and the second common representation into the MLLM.

D: The system of any of paragraphs A-C, the operations further comprising: receiving input text indicating a condition for the MLLM to consider during processing; and inputting, into the MLLM, the input text.

E: The system of any of paragraphs A-D, wherein: the autonomous vehicle comprises a vehicle computing device having first computational resources, and the MLLM utilizes second computational resources remote from the vehicle computing device, the second computational resources greater than the first computational resources.

F: One or more non-transitory computer-readable media storing instructions executable by one or more processors, wherein the instructions, when executed, cause the one or more processors to perform operations comprising: receiving a request for assistance from a vehicle indicating an event in an environment; inputting first data associated with a first data format and second data associated with a second data format into a large language model (LLM), the first data associated with a first source and the second data associated with a second source different from the first source; receiving, from the LLM and based at least in part on the first data and the second data, a solution for the vehicle relative to the event; and transmitting the solution to the vehicle, the solution configured to cause a planning component of the vehicle to determine a trajectory to navigate the vehicle in the environment.

G: The one or more non-transitory computer-readable media of paragraph F, wherein the first data comprises sensor data associated with a sensor of the vehicle and the second data comprises map data.

H: The one or more non-transitory computer-readable media of paragraph F or G, the operations further comprising: inputting the first data into a first machine learned model and the second data into a second machine learned model different form the first machine learned model; receiving first output data from the first machine learned model and second output data from the second machine learned model; and inputting, as input data, the first output data and the second output data into the LLM.

I: The one or more non-transitory computer-readable media of paragraph H, the operations further comprising: inputting the first output data into a first projector; receiving, from the first projector, a first common representation; inputting the second output data into a second projector; receiving from the second projector, a second common representation; and inputting the first common representation and the second common representation into the LLM.

J: The one or more non-transitory computer-readable media of any of paragraphs F-I, the operations further comprising: receiving input text indicating a condition for the LLM to consider during processing; and inputting, into the LLM, the input text.

K: The one or more non-transitory computer-readable media of any of paragraphs F-J, wherein: the vehicle comprises a vehicle computing device having first computational resources, and the LLM utilizes second computational resources that are greater than the first computational resources.

L: The one or more non-transitory computer-readable media of any of paragraphs F-K, wherein: transmitting the solution to a user interface associated with an operator; receiving, from the user interface, an input comprising a suggested command for the vehicle to execute; and transmitting the input the vehicle.

M: The one or more non-transitory computer-readable media of any of paragraphs F-L, wherein the LLM is trained based at least in part on log data received from an additional vehicle and associated solution data associated with an operator.

N: The one or more non-transitory computer-readable media of any of paragraphs F-M, the operations further comprising: receiving text associated with a user input from a user interface; determining a token to represent the text; and inputting the token into the LLM.

O: The one or more non-transitory computer-readable media of any of paragraphs F-N, wherein: the first data in the first data format is received from a tokenizer, and the second data in the second data format is received from a multilayer perceptron.

P: The one or more non-transitory computer-readable media of any of paragraphs F-O, wherein: the solution represents a token or a waypoint for the vehicle to navigate relative to the event.

Q: A method comprising: receiving a request for assistance from a vehicle indicating an event in an environment; inputting first data associated with a first data format and second data associated with a second data format into a large language model (LLM), the first data associated with a first source and the second data associated with a second source different from the first source; receiving, from the LLM and based at least in part on the first data and the second data, a solution for the vehicle relative to the event; and transmitting the solution to the vehicle, the solution configured to cause a planning component of the vehicle to determine a trajectory to navigate the vehicle in the environment.

R: The method of paragraph Q, further comprising: inputting the first data into a first machine learned model and the second data into a second machine learned model different form the first machine learned model; receiving first output data from the first machine learned model and second output data from the second machine learned model; and inputting, as input data, the first output data and the second output data into the LLM.

S: The method of paragraph R, further comprising: inputting the first output data into a first projector; receiving, from the first projector, a first common representation; inputting the second output data into a second projector; receiving from the second projector, a second common representation; and inputting the first common representation and the second common representation into the LLM.

T: The method of any of paragraphs Q-S, further comprising: receiving input text indicating a condition for the LLM to consider during processing; and inputting, into the LLM, the input text.

While the example clauses described below are described with respect to one particular implementation, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

### CONCLUSION

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

What is claimed is:

1. A system comprising:
one or more processors; and
one or more non-transitory computer-readable media storing instructions executable by the one or more processors, wherein the instructions, when executed, cause the system to perform operations comprising:
receiving data associated with an autonomous vehicle;
receiving a request from the autonomous vehicle to assist with an event in an environment;
retrieving, based at least in part on receiving the request, map data from a database associated with the autonomous vehicle, the map data describing a region of the environment within a threshold distance from the autonomous vehicle;
inputting the data and the map data into a multimodal large language model (MLLM);
receiving, from the MLLM, text indicating a solution for the event; and
transmitting the solution to the autonomous vehicle, wherein the solution is configured to cause a planning component of the autonomous vehicle to determine a trajectory to navigate the autonomous vehicle in the environment.

2. The system of claim 1, wherein the data comprises a first portion structured as image data, and the operations further comprising:
inputting the image data into an image model;
inputting the map data into a scene model;
receiving first output data from the image model;
receiving second output data from the scene model; and
inputting, as input data, the first output data and the second output data into the MLLM.

3. The system of claim 2, wherein inputting the input data comprises:
inputting the first output data into a first projector;
receiving, from the first projector, a first common representation;
inputting the second output data into a second projector;
receiving from the second projector, a second common representation; and
inputting the first common representation and the second common representation into the MLLM.

4. The system of claim 1, the operations further comprising:
receiving input text indicating a condition for the MLLM to consider during processing; and
inputting, into the MLLM, the input text.

5. The system of claim 1, wherein:
the autonomous vehicle comprises a vehicle computing device having first computational resources, and
the MLLM utilizes second computational resources remote from the vehicle computing device, the second computational resources greater than the first computational resources.

6. One or more non-transitory computer-readable media storing instructions executable by one or more processors, wherein the instructions, when executed, cause the one or more processors to perform operations comprising:
receiving a request for assistance from a vehicle indicating an event in an environment;
inputting first data associated with a first data format and second data associated with a second data format into a large language model (LLM), the first data associated with a first source and the second data associated with a second source different from the first source;
receiving, from the LLM and based at least in part on the first data and the second data, a solution for the vehicle relative to the event; and
transmitting the solution to the vehicle, the solution configured to cause a planning component of the vehicle to determine a trajectory to navigate the vehicle in the environment.

7. The one or more non-transitory computer-readable media of claim 6, wherein the first data comprises sensor data associated with a sensor of the vehicle and the second data comprises map data.

8. The one or more non-transitory computer-readable media of claim 6, the operations further comprising:
inputting the first data into a first machine learned model and the second data into a second machine learned model different form the first machine learned model;
receiving first output data from the first machine learned model and second output data from the second machine learned model; and
inputting, as input data, the first output data and the second output data into the LLM.

9. The one or more non-transitory computer-readable media of claim 8, the operations further comprising:
inputting the first output data into a first projector;
receiving, from the first projector, a first common representation;
inputting the second output data into a second projector;
receiving from the second projector, a second common representation; and
inputting the first common representation and the second common representation into the LLM.

10. The one or more non-transitory computer-readable media of claim 6, the operations further comprising:
receiving input text indicating a condition for the LLM to consider during processing; and
inputting, into the LLM, the input text.

11. The one or more non-transitory computer-readable media of claim 6, wherein:
the vehicle comprises a vehicle computing device having first computational resources, and
the LLM utilizes second computational resources that are greater than the first computational resources.

12. The one or more non-transitory computer-readable media of claim 6, wherein:
transmitting the solution to a user interface associated with an operator;
receiving, from the user interface, an input comprising a suggested command for the vehicle to execute; and
transmitting the input the vehicle.

13. The one or more non-transitory computer-readable media of claim 6, wherein the LLM is trained based at least in part on log data received from an additional vehicle and associated solution data associated with an operator.

14. The one or more non-transitory computer-readable media of claim 6, the operations further comprising:
receiving text associated with a user input from a user interface;
determining a token to represent the text; and
inputting the token into the LLM.

15. The one or more non-transitory computer-readable media of claim 6, wherein:
the first data in the first data format is received from a tokenizer, and
the second data in the second data format is received from a multilayer perceptron.

16. The one or more non-transitory computer-readable media of claim 6, wherein:
the solution represents a token or a waypoint for the vehicle to navigate relative to the event.

17. A method comprising:
receiving a request for assistance from a vehicle indicating an event in an environment;
inputting first data associated with a first data format and second data associated with a second data format into a large language model (LLM), the first data associated with a first source and the second data associated with a second source different from the first source;
receiving, from the LLM and based at least in part on the first data and the second data, a solution for the vehicle relative to the event; and
transmitting the solution to the vehicle, the solution configured to cause a planning component of the vehicle to determine a trajectory to navigate the vehicle in the environment.

18. The method of claim 17, further comprising:
inputting the first data into a first machine learned model and the second data into a second machine learned model different form the first machine learned model;
receiving first output data from the first machine learned model and second output data from the second machine learned model; and
inputting, as input data, the first output data and the second output data into the LLM.

19. The method of claim 18, further comprising:
inputting the first output data into a first projector;
receiving, from the first projector, a first common representation;
inputting the second output data into a second projector;
receiving from the second projector, a second common representation; and
inputting the first common representation and the second common representation into the LLM.

20. The method of claim 17, further comprising:
receiving input text indicating a condition for the LLM to consider during processing; and
inputting, into the LLM, the input text.
